(19) United States
(12) Patent Application Publication
(10) Pub. No.: US 2003/0002957 A1
(43) Pub. Date: Jan. 2, 2003

(54) Door dolly

(76) Inventor: Ricky D. Etheredge, San Angelo, TX (US)

Correspondence Address: THE LAW OFFICES OF H. DENNIS KELLY, 2401 TURTLE CREEK, DALLAS, TX, 75219, US

(21) Appl. No.: 09/897,515

(22) Filed: Jul. 2, 2001

(51) Int. Cl. B62B 1/26; B25B 11/00

(52) U.S. Cl. 414/11; 269/17; 269/905; 280/47.24; 280/47.34

(57) ABSTRACT

A door dolly (11) has a side leg (17) rigidly attached to a bottom leg (15) and a wheel and axle assembly (21) attached to the side leg (17) near the bottom leg (15). A handle (19) attaches to the side leg (17) distal to the bottom leg (15). The handle (19) is configured to act as a support for the side leg (17) when the dolly (11) is positioned with the side leg (17) substantially level with the floor, so that the dolly (11) can also act as a stand for holding a door (13) placed on the dolly (11).

### TECHNICAL FIELD

This invention relates in general to a dolly for transporting doors. In particular, the invention relates to a dolly for transporting doors that can also be used as a stand for holding a door while work is performed on the door.

### BACKGROUND ART

Dollies for carrying large flat sheets of materials are well known. Dollies have also been devised specifically for carrying doors, usually with the door oriented substantially as installed, that is, with the longest dimension vertical.

On construction sites, it is often desirable to position the door with the sides horizontal, such as when planing edges and installing hinge plates. Conventional dollies usually require the door to be removed, turned ninety degrees, and placed back on the dolly, assuming the particular dolly is even capable of holding the door in this position. A dolly that can be readily repositioned to act as a stand to hold the door sideways without the need to remove and reposition the door is very desirable.

U.S. Pat. No. 4,746,141, issued to Willis on May 24, 1988, discloses a collapsible door carrier that can be placed on its side to act as a stand. A longer side leg attaches to a bottom leg via a hinge for collapsibility, and a wheel and axle assembly attaches to the side leg near the junction with the bottom leg. The side leg is bisected by another hinge for further collapsibility. A projection located on the side leg distal to the bottom leg provides means to hold the side leg level when the carrier is tipped onto its side.

The Willis device has several drawbacks. Braces are required to support the hinged junction of the bottom and side legs for carrying a typical load. A hinged angle brace is mounted on each side of the side leg and the bottom leg, forming the hypotenuse of a forty-five degree right triangle with the side leg and the bottom leg during normal use. The braces are an obstruction when placing a door in the carrier or removing it therefrom. If care is not taken during placement and removal, the door can strike or scrape against the braces, causing damage to the door's finish. Making the carrier collapsible significantly increases the complexity, parts count and cost of the Willis device and reduces its durability. Collapsibility is not considered a sufficiently necessary feature to outweigh the disadvantages, since there is normally enough storage space available to store a door carrier that will not collapse. Finally, the Willis device has a handle mounted at right angles to the plane containing the side and bottom legs. This handle presents a tripping hazard when the side leg is level with the ground. The handle can also be stepped on, causing the carrier and its load to tip over onto the user.

### DISCLOSURE OF INVENTION

In general, a structure that avoids the drawbacks of existing devices is achieved by a bottom leg rigidly attached to a side leg, an axle and wheel assembly attached to the side leg near the junction with the bottom leg, and a side support attached to the side leg distal to the axle in the plane with the side leg and the bottom leg. A wheel and axle assembly is attached to the side leg near the junction with the bottom leg, and provides the means for rotating the door dolly between a first position wherein the bottom leg is substantially level with the ground and a second position wherein the side leg is substantially level with the ground. “Substantially level” as used in this specification and the claims is defined as parallel plus or minus about one degree. The side support preferably is a substantially rectangular loop, with the longer side parallel to the side leg. The loop can also act as a handle for holding and directing the door dolly when transporting a door. The use of a loop provides a large surface for contact with the ground when used as a side leg support, and is inherently coplanar with the side leg and the bottom leg, without projections that could present a safety hazard.

Further features and advantages of the invention will become apparent in the following detailed description and in the drawings.

### BRIEF DESCRIPTION OF THE DRAWINGS

FIG. 1a is a perspective view of the door dolly according to the invention, as it appears when in use transporting a door.

FIG. 1b is an identical view of the door dolly as in FIG. 1a with the door removed to reveal previously hidden elements.

FIG. 2a is a right side elevation of the dolly at rest, with the longer side oriented vertically.

FIG. 2b is a right side elevation of the dolly at rest, with the longer side oriented horizontally

FIG. 3 is a an front elevation of the dolly, showing details of the channels defined by the legs.

FIG. 4 is a right side detail of the structure around the dolly's elbow, with the front wheel removed for clarity.

### BEST MODE FOR CARRYING OUT THE INVENTION

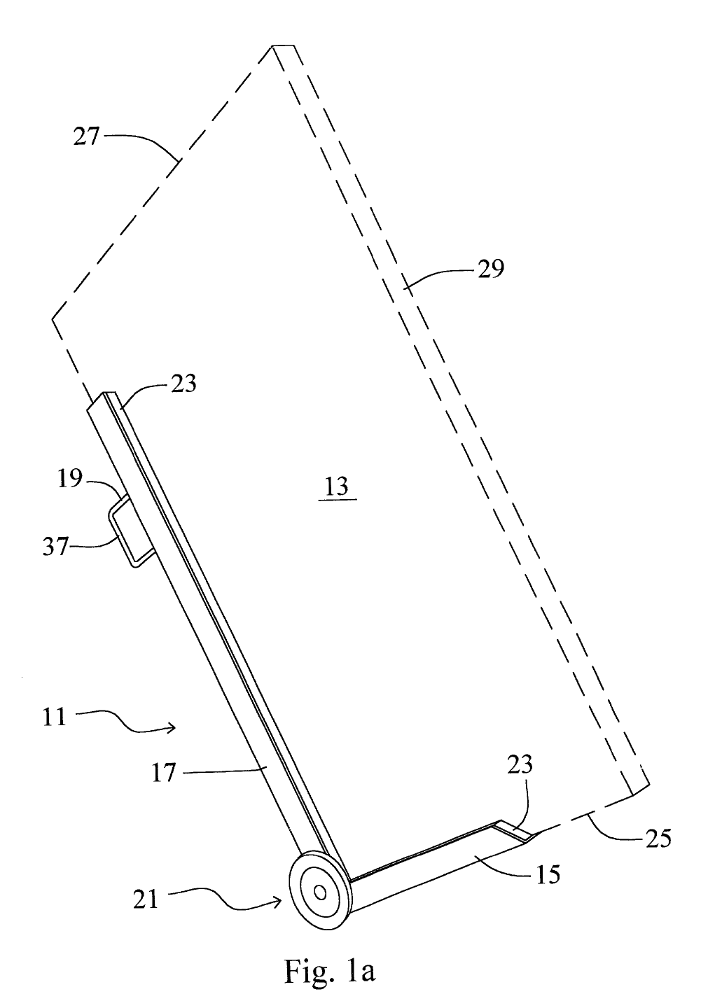

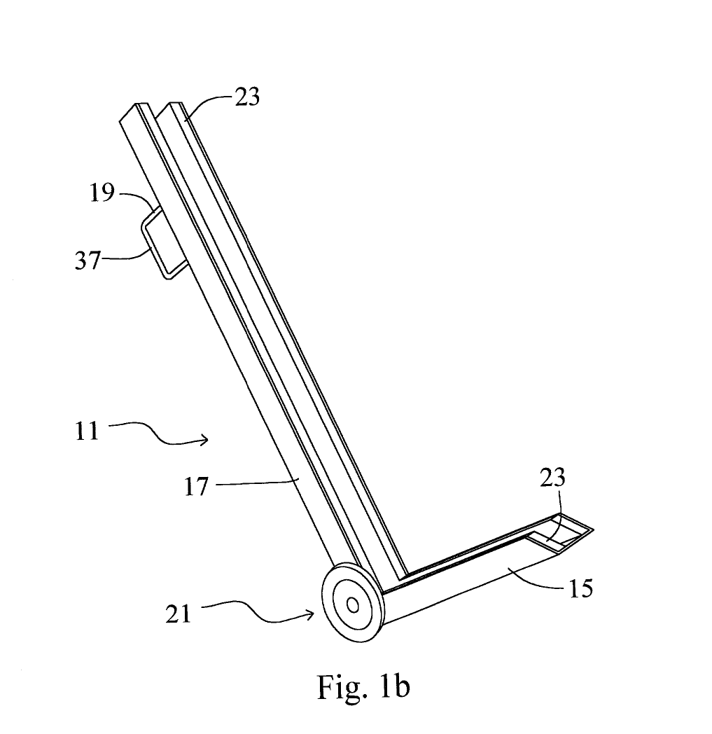

FIG. 1a shows the preferred embodiment of the door dolly 11 of the invention being used to carry a door 13. The door dolly 11 includes a bottom leg 15, a side leg 17, a handle 19 attached to the side leg 17, and a wheel and axle assembly 21 attached to the side leg 17 near the junction with the bottom leg 15.

As shown in FIGS. 1b and 3, the bottom leg 15 is an elongated, U-shaped channel with a liner 23 made from a soft material such as carpeting or a soft wood to protect the door's finish. The bottom leg 15 provides the means for supporting the bottom edge 25 of the door while transporting the door. If desired, another liner 37 made of wood, carpeting, or other soft, non-scratching material can be applied to protect the door bottom edge 25, as shown in FIG. 3. Obviously, the top edge 27 of the door can be equally well supported by the bottom leg 15 if desired. The length of the bottom leg 15 should be at least about sixty-five percent of the length of the door's bottom edge 25 for proper support.

The side leg 17 uses the same construction as the bottom leg 15, but is longer for proper support of the door 13 when the door dolly 11 is used as a stand. The length of the side leg 17 should be at least about eighty percent of the length of the door's side edge 29 for proper support. The side leg 17 is a single rigid piece, without added structure to make the leg collapsible or telescoping.

Both the bottom leg 15 and the side leg 17 can be made with other configurations, so long as the particular configuration performs the critical functions of securely supporting the particular edge, and preventing the edge from falling off the device. For example, a flat bar can be used for each leg, with upright retaining flanges set at intervals along the length of the bar. Clamps can be used in place of flanges, but are discouraged since they add cost and complexity, and usually have projecting parts that can present a safety hazard. As another example, a leg having an shallow arcuate cross-section can be used in place of the preferred U-shaped channel or the flat bar with retaining elements. Other configurations known in the art can also be used within the scope of the invention.

As already described, a wheel and axle assembly 21 is attached to the side leg 17 near the junction with the bottom leg 15. As shown in detail in FIG. 4, the axle 31 is located so that each wheel 33 extends about one-eighth inch (three millimeters) below the bottom edge 35 of the bottom leg 15. This distance can be varied, the objective being to situate the bottom leg 15 close enough to the floor so that it can be wheeled under an installed door prior to removing the door from the surrounding doorframe.

The handle 19 is located on the side leg 17 on the distal end from the junction of the side leg 17 and the bottom leg 15. Five-eighth inch nominal diameter (sixteen millimeter) cold-rolled iron pipe is preferred because it is durable, inexpensive and easy to shape, but other materials can be used, such as square metal tubing. The shape of the handle 19 is not critical, except that it should be substantially planar and the portion 37 of the handle farthest from the side leg 17 should be straight and long enough to present a large surface area for contacting a floor, the ground, or a similarly flat, level support surface when the dolly is laid on its side as described below.

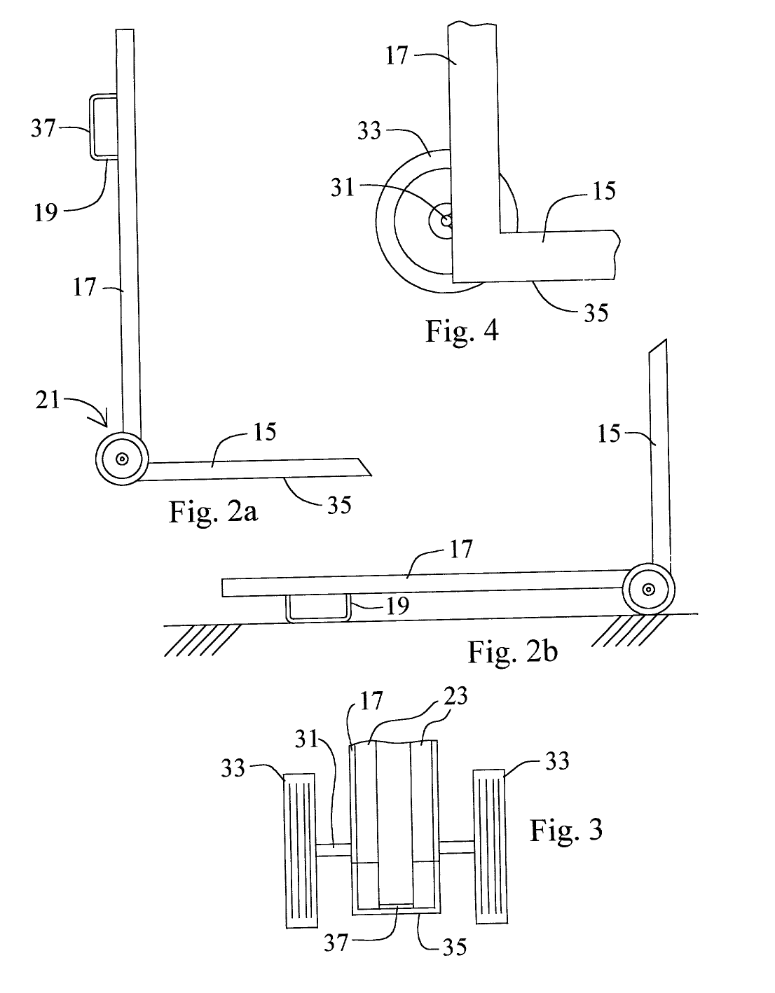

The dolly is designed to operate generally in three different positions. The wheel and axle assembly provide a pivot to permit the door dolly to be turned easily from one position to another. In the first position, shown in FIG. 2a, the door dolly 11 is used to pick up and transport the door. In this position, the bottom leg 15 is substantially level with the ground. In the next position, the dolly is tilted about the axle 31 with the bottom leg 15 at an angle of about five to forty degrees with respect to the floor, so that the door can be transported, as shown in FIG. 1a. In the last position, shown in FIG. 2b, the dolly is turned about ninety degrees from the first position, so that the side leg is substantially level with the ground. The side leg is supported in this position by the wheels 33 and by the handle 19, which now functions as a support leg. In this position, work can be performed on the door, such as planing edges and installing hinge plates. As previously discussed, the handle should have a fairly large straight portion 37 contacting the floor in this position to give greater stability to the dolly 11. The portion 37 contacting the floor can be widened somewhat for greater lateral stability, but the handle 19 should remain substantially coplanar with the side leg 17 and the bottom leg 15, meaning that no part of the handle 19 should extend further than about an inch (25 millimeters) beyond the edges of the side leg 17 in a direction perpendicular to the plane containing the side leg 17 and the bottom leg 15.

The invention has several advantages over the prior art. The door dolly is simple in design, but is rugged and durable. It has no complicated moving parts, and a minimum of edges and surfaces that can damage the door's finish. The handle does not present a safety hazard while the side leg is placed parallel to the floor. Since all the major parts except the axle and wheels lie in a single plane, the dolly can be stored along a wall, taking up minimal space.

The invention has been shown in only one embodiment, although alternative embodiments have been described. It should be apparent to those skilled in the art that the invention is not limited to these embodiments, but is capable of being varied and modified without departing from the scope of the invention as set out in the attached claims.

1. A door dolly for use on a support surface with a door having a bottom edge, a top edge, and a pair of opposed side edges, wherein the door dolly comprises:
rigid bottom means for supporting either the bottom edge or the top edge of the door;
rigid side means for supporting one of the side edges of the door, connected to the bottom means at a fixed angle and substantially coplanar with the bottom means;
means for rotating the door dolly from a first position where the bottom means is substantially level with the support surface and a second position where the side means is substantially level with the support surface; and
support means attached to and substantially coplanar with the side means for supporting the side means when the door dolly is in the second position.

2. A door dolly as recited in claim 1, wherein the bottom means comprises an elongated U-shaped channel adapted to receive the bottom edge of the door, and wherein the side means comprises an elongated U-shaped channel adapted to receive one of the side edges of the door and having a length equal to at least about eighty percent of the length of the door side edge.

3. A door dolly as recited in claim 1, wherein the means for rotating the door dolly comprises an axle attached to the side means and having two ends, and two wheels attached to the axle with a wheel at each end of the axle.

4. A door dolly as recited in claim 3, wherein the bottom means has a bottom surface, and the axle is located on the side means so that the lowest point on each wheel extends slightly below the bottom surface of the bottom means.

5. A door dolly as recited in claim 1, wherein the support means comprises a tubular loop having a straight side distal to the side means and offset therefrom.

6. A door dolly as recited in claim 2, wherein the side leg and the bottom leg are lined with a soft material to protect the finish of the door.

7. A door dolly for use on a support surface with a door having a bottom edge, a top edge, and a pair of opposed side edges, wherein the door dolly comprises:
a bottom leg;
a substantially straight side leg rigidly connected to the bottom leg and substantially coplanar with the bottom leg;
an axle attached to the side leg and having two ends;
two wheels attached to the axle with one wheel at each end of the axle; and
support means attached to the side leg and substantially coplanar with the side leg and the bottom leg for supporting the side leg substantially level with the support surface.

8. A door dolly as recited in claim 7, wherein the bottom leg has a U-shaped channel adapted to receive the bottom edge of the door, and the side leg has a U-shaped channel adapted to receive one of the side edges of the door, and the side leg has a length equal to at least about eighty percent of the length of the door side edge.

9. A door dolly as recited in claim 7, wherein the support means comprises a tubular loop having a straight side distal to the side means and offset therefrom.

10. A door dolly as recited in claim 7, wherein the side leg and the bottom leg are lined with a soft material to protect the finish of the door.
